(19) United States
(12) Patent Application Publication
(10) Pub. No.: US 2007/0189823 A1
(43) Pub. Date: Aug. 16, 2007

(54) Image forming apparatus and image forming method

(75) Inventor: Eun-young Baek, Gunpo-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd, Suwon-si (KR)

(21) Appl. No.: 11/703,134

(22) Filed: Feb. 7, 2007

(30) Foreign Application Priority Data
Feb. 10, 2006 (KR) 2006-12885

(51) Int. Cl. G03G 15/00

(52) U.S. Cl. 399/396

(57) ABSTRACT

An image forming apparatus, including a pick-up roller to pick up a printing medium, a printing unit to print an image on the printing medium, and a feeding roller to convey the picked up printing medium to the printing unit. A pick-up velocity, at which the pick-up roller picks up the printing medium, is smaller than a feeding velocity, at which the feeding roller conveys the picked up printing medium to the printing unit.

### CROSS-REFERENCE TO RELATED APPLICATIONS

This application claims the benefit of Korean Patent Application No. 2006-12885, filed on Feb. 10, 2006, in the Korean Intellectual Property Office, the disclosure of which is incorporated herein in its entirety by reference.

### BACKGROUND OF THE INVENTION

1. Field of the Invention

Aspects of the present invention relate to an image forming apparatus and an image forming method, and, more particularly, to an image forming apparatus and an image forming method that prevents a pick-up skew of a printing medium, i.e., a misalignment of a printing medium occurring due to an impact occurring during a movement of the printing medium.

2. Description of the Related Art

Typically, an image forming apparatus that prints an image on a printing medium includes a pick-up roller that picks up a printing medium stacked in a printing medium stacking tray, a printing unit that forms an image on the printing medium, and a feeding unit that conveys the picked up printing medium to the printing unit. The pick-up velocity is the velocity by which the pick-up roller picks up the printing medium and the feeding velocity is the velocity by which the picked up printing medium is conveyed to the printing unit. Generally, the pick-up velocity is larger than the feeding velocity.

When the printing medium is picked up, the velocity of the printing medium increases from zero to the pick-up velocity due to frictional contact between the printing medium and the peripheral face of the pick-up roller. This rapid increase of the velocity acts as an impact on the printing medium and tends to generate a pick-up skew of the printing medium. Here, the pick-up skew refers to a phenomenon in which a printing medium becomes misaligned and skewed due to the pick-up impact.

In particular, in the case of high speed printing of over 40 ppm (pages per minute), the pick-up velocity is relatively high. As such, the impact on the printing medium is larger than that which is generated during low speed printing. As a result, a larger type of pick-up skew of the printing medium is generated, which tends to cause paper jams or other types of degradations of printing quality.

### SUMMARY OF THE INVENTION

Aspects of the present invention provide an image forming apparatus and an image forming method to prevent an occurrence of pick-up skew by setting a pick-up velocity and a feeding velocity to be different from those of the conventional image forming apparatuses and methods.

According to an aspect of the present invention, there is provided an image forming apparatus, including a pick-up roller to pick up a printing medium, a printing unit to print an image on the printing medium, and a feeding roller to convey the picked up printing medium to the printing unit. A pick-up velocity, at which the pick-up roller picks up the printing medium, is smaller than a feeding velocity, at which the feeding roller conveys the picked up printing medium to the printing unit.

According to an embodiment of the invention, the printing unit comprises a photosensitive medium on which a visual toner image is developed by toner supplied onto an electrostatic latent image formed by an irradiated light, a transfer roller transferring the toner image from the photosensitive medium to the printing medium, and a fuser fusing and fixing the transferred toner image on the printing medium.

The pick-up velocity is smaller than a photosensitive medium velocity at which the printing medium proceeds by the rotation of the photosensitive medium and the feeding velocity is larger than the photosensitive medium velocity.

According to an embodiment of the invention, according to an embodiment of the present invention, the pick-up velocity and feeding velocity are determined such that the average moving velocity at which the printing medium proceeds from the position where a front end of the printing medium is picked up by the pick-up roller to the position where the front end approaches the photosensitive medium is equal to the photosensitive medium velocity.

The present invention also provides an image forming method including picking up a printing medium by a pick-up roller, feeding the picked up printing medium to a printing unit, and printing an image on the printing medium by the printing unit, wherein a pick-up velocity at which the pick-up roller picks up the printing medium is smaller than a feeding velocity at which the feeding roller conveys the picked up printing medium.

According to another aspect of the present invention, there is provided a method of printing of an image on the printing medium by the printing unit comprises forming an electrostatic latent image on a photosensitive medium by irradiating light thereon, developing a visual toner image by supplying toner to the electrostatic latent image, transferring the toner image from the photosensitive medium to the printing medium, and fusing and fixing the transferred toner image on the printing medium.

In transferring the toner image, the pick-up velocity is smaller than a photosensitive medium velocity at which the printing medium proceeds by the rotation of the photosensitive medium and the feeding velocity is larger than the photosensitive medium velocity.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a cross-sectional view of an image forming apparatus according to a preferred embodiment of the present invention; and

FIG. 2 is a view for explaining a method of determining a pick-up velocity and a feeding velocity in the image forming apparatus of FIG. 1.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

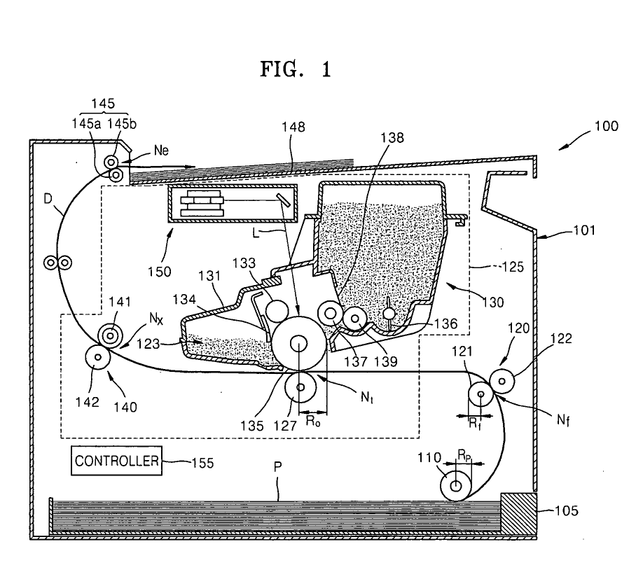

FIG. 1 is a cross-sectional view of an image forming apparatus 100 according to an embodiment of the present invention. A shown in FIG. 1, the image forming apparatus 100 is an electrophotographic image forming apparatus that prints an image by supplying a developing agent such as toner onto an electrostatic latent image formed on the outer peripheral face of a photosensitive medium 13 by scanning a laser beam on the photosensitive medium 13, developing the electrostatic latent image into a toner image, and transferring the toner image onto a printing medium and fusing and fixing it thereon.

A printing medium P moves from a bottom area of the image forming apparatus 100 to a top area thereof along an approximately S shaped path D defined through the image forming apparatus. The image forming apparatus 100 includes a printing unit 125 located inside a case 101, a stacking tray 105, on which the printing medium P is stacked before printing, and a discharging tray 148, on which the printing medium P is stacked after having an image printed thereon. Also, the image forming apparatus includes a controller 155 to control a moving velocity of the printing medium P along the path D. The printing unit 125 includes a developer 130 that is removably mounted in the case 101, a fuser 140, a transfer roller 127, and a light scanner 150.

The developer 130 includes a housing 131 that stores a developing agent, such as toner, a photosensitive medium 135 placed inside the housing 131 and on which the electrostatic latent image is formed by light the scanning of the laser beam, a charging roller 133 to charge the photosensitive medium 135, a toner cleaner 134 to clean toner remaining on the photosensitive medium 135, a developing roller 137 to supply the toner to the electrostatic latent image formed on the outer peripheral face of the photosensitive medium 135 and to develop a toner image thereon, a doctor blade 138 to regulate a thickness of the toner attached on the surface of the developing roller 137, and a supplying roller 139 to supply the toner to the developing roller 137. The developer 130 includes an agitator 136 to agitate the toner in the housing 131. The developer 130 may be replaced when the toner contained in the housing 130 is exhausted.

The transfer roller 127 contacts the photosensitive medium 135 and forms a transfer nip Nₜ therewith. A transfer biased voltage is supplied to the transfer roller 127. The toner image formed on the outer peripheral surface of the photosensitive medium 135 is transferred onto the printing medium P that passes bellow the photosensitive medium 135 by a pressing force of the transfer roller 137 and the transfer biased voltage. The light scanner 150 irradiates a light beam L onto the photosensitive medium 135 corresponding to the image to be printed, and may comprise a laser scanning unit (LSU) using a laser diode as a light source.

The fuser 140 includes a heating roller 141 and a pressing roller 142 that form a fusing nip Nₓ. When the printing medium P passes through the fusing nip Nₓ formed between the heating roller 141 and the pressing roller 142, the toner image is fused on the printing medium P by an application of heat and pressure.

A pair of discharging unit 145 rollers 145a and 145b to discharge the printing medium P, on which the toner image is printed, to the discharging tray 148 are disposed above the fuser and outside of the case 101. The discharging unit 145 rollers 145a and 145b form an ejecting nip Nₑ. According to an embodiment of the invention, one roller of the discharging unit 145 is a driving roller and the other roller is an idle roller.

The stacking tray 105 may comprise a cassette that is detachably mounted in the case 101. The image forming apparatus 100 also includes a pick-up roller 110 to pick up the printing medium P by frictional contact between the pick-up roller 110 with the printing medium P stacked in the stacking tray 105, and a feeding unit 120 to convey the printing medium P to the printing unit 125. The pick-up roller 110 comprises a substantially circular cross-section, however, in another embodiment of the invention, the pick-up roller 110 may comprise a substantially semi-circular cross-section. The feeding unit 120 includes a pair of rollers 121 and 122 that form a feeding nip N_{f}. The roller 121 comprises a driving roller and the roller 122 comprises an idle roller. Unlike the image forming apparatus 100 illustrated in FIG. 1, in another embodiment of the present invention, two or more pairs of feeding units and registration rollers to properly arrange a printing medium may be provided. Also, according to another embodiment of the present invention, the feeding 120 unit may operate as a registration roller as well.

The pick-up velocity Vₚ, at which the printing medium P is picked up by the pick-up roller 110, is smaller than the feeding velocity V_{f}, at which the feeding roller 120 conveys the picked up printing medium P to the printing unit 125. The pick-up velocity Vₚ is the linear velocity of the outer peripheral face of the pick-up roller-110 that contacts the printing medium P. Therefore, the pick-up velocity is determined by multiplying the radius Rₚ of the pick up roller 110 by the angular velocity thereof. Also, the feeding velocity V_{f} is determined by multiplying the radius R_{f} of the driving roller 121 by the angular velocity thereof. The controller 155 controls the angular velocity of the pick-up roller 110 and driving roller 121.

In the present invention, the pick-up velocity is designed to be relatively slow enough so as to prevent a pick-up skew of the printing paper P when the pick-up roller contacts the printing medium P, whereas the feeding velocity is designed to be relatively fast enough so as to compensate for the slow pick-up velocity. In the meantime, in the image forming apparatus 100, the velocity at which the printing medium P proceeds by the rotation of the photosensitive medium 135 is defined as a printing medium velocity Vₒ. If the feeding velocity V_{f} is smaller than the photosensitive medium velocity Vₒ, the printing medium P moves at the photosensitive medium velocity Vₒ, and a slipping of the paper may be caused when the printing medium P passes through the feeding nip N_{f} and the transfer nip Nₜ concurrently. Thus, a paper jam or low quality printing may be generated. Therefore, according to an embodiment of the invention, the feeding velocity V_{f} is larger than the photosensitive medium velocity Vₒ and the pick-up velocity Vₚ is smaller than the photosensitive medium velocity Vₒ.

According to an aspect of the present invention, from the position where the front end of the printing medium P is picked up by the pick-up roller 110 to the position where the front end approaches the photosensitive medium 135, in particular, when the front end approaches the transfer nip Nₜ, the average velocity of the printing medium P is to be equal to the photosensitive medium velocity Vₒ. The photosensitive medium velocity Vₒ is determined by multiplying the radius Rₒ of the photosensitive medium 135 by the angular velocity thereof. The controller 155 controls the angular velocity of the photosensitive medium 135.

Hereinafter, an image forming method used by the image forming apparatus 100 will be explained. The photosensitive medium 135 is charged with a predetermined potential through the charging roller 133 and the latent image corresponding to the image to be printed is formed on the outer peripheral face of the photosensitive medium 135 by scanning a light beam L from the light scanner 150 thereon. The toner in the developer housing 131 is supplied to the photosensitive medium 135 through a supply roller 139 and a developing roller 137. Thus, the toner image is developed on the outer peripheral face of the photosensitive medium 135. In the meantime, the printing medium P is picked up by the pick-up roller 110 and conveyed to the printing unit 125 by the feeding unit 120. Then, the printing medium P passes through the transfer nip Nₜ between the photosensitive medium 135 and the transfer roller 127. At this time, the toner image developed on the outer peripheral face of the photosensitive medium 135 is transferred to the printing medium P, which passes below the photosensitive medium 135. Afterwards, the printing medium P passes through the fusing nip Nₓ in the fuser 140 and the toner image is fused and fixed on the printing medium P by an application of heat and pressure. Then, the printing medium P is discharged from the interior of the image forming apparatus by the discharging unit 145 and is stacked on the discharging tray 148.

The velocity of the printing medium P increases from zero to the pick-up velocity Vₚ by the rotation of the pick-up roller 110 and the friction between the surface of the pick-up roller 110 and the printing medium P. When the front end of the printing medium P, picked up by the pick-up roller 110, approaches the feeding nip N_{f}, the printing medium P moves with the feeding velocity V_{f} by the feeding unit 120, which is faster than the pick-up velocity Vₚ. When the front end of the printing medium P passes through the feeding nip N_{f} while the rear end thereof remains in contact with the pick-up roller 110, the pick-up roller 110 rotates in an idle state.

A clutch (not shown), i.e., a power transmission member, is placed between the pick-up roller 110 and a motor (not shown) in order to actuate the pick-up roller 110. When the clutch connects the pick-up roller 110 with the motor, the pick-up roller 110 starts rotating. In this case, the linear velocity of the outer peripheral face of pick-up roller 110 is the pick-up velocity Vₚ. However, when the front end of the printing medium P approaches the feeding nip N_{f} and the printing medium P moves with the feeding velocity V_{f} that is faster than the pick-up velocity Vₚ, the clutch disconnects the pick-up roller 110 from the motor such that the pick-up roller 110 rotates in an idle state. The structure of the clutch is known to those skilled in the art so that a detailed explanation thereof is omitted.

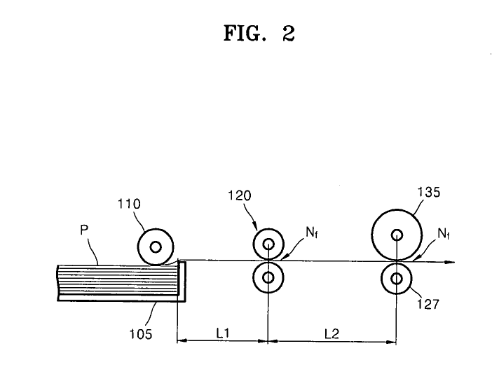

FIG. 2 is a view to explain a method of determining the pick-up velocity and the feeding velocity of the image forming apparatus of FIG. 1. As is explained above with reference to FIG. 1, until the front end of the printing medium P reaches the photosensitive medium 135 after being picked up by the pick-up roller 110, the average moving velocity of the printing medium P is equal to the photosensitive medium velocity Vₒ. With reference to FIG. 2, this relationship is as follows.

$$\frac{L 1 + L 2}{Vo} = \frac{L 1}{Vp} + \frac{L 2}{Vf}$$

Here, L1 is a distance traveled by the front end of the printing medium P from the stacking tray 105 to the feeding nip N_{f}, and L2 is a distance traveled by the front end of the printing medium P from the feeding nip N_{f} to the transfer nip Nₜ.

In the conventional method, the pick-up velocity is faster than the feeding velocity, but, according to aspects of the present invention, the pick-up velocity Vₚ is slower than the feeding velocity V_{f}. The method of the present invention may be used even for an image forming apparatus having high printing velocity (for example, 40 ppm). In this case, the pick-up velocity Vₚ is lower compared to that of the conventional method, and the feeding velocity V_{f} is higher compared to that of the conventional method. Since the pick-up velocity Vₚ is slower than the pick-up velocity in the conventional method, the impact on the printing medium P is small during pick up, and, thus, a pick-up skew of the printing medium P is substantially prevented. Since the feeding velocity V_{f} is higher than the feeding velocity in the conventional method, even though the pick-up velocity is smaller than in the conventional method, the printing velocity of the present invention is substantially similar to the printing velocity in the conventional method as long as the pick-up interval of the printing medium in the present invention remains substantially similar to that of the conventional method.

According to the image forming apparatus and the image forming method of the invention, the pick-up velocity is smaller than the feeding velocity so that pick-up skew of the printing medium is prevented. In particular, during high speed printing, a paper jam or a degradation of printing quality due to the pick-up skew is prevented. Aspects of the present invention may also be used for an inkjet type image forming apparatus including an inkjet head as a printing unit.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An image forming apparatus, comprising:
a pick-up roller to pick up a printing medium;
a printing unit to print an image on the printing medium; and
a feeding roller to convey the picked up printing medium to the printing unit, wherein a pick-up velocity, at which the pick-up roller picks up the printing medium, is smaller than a feeding velocity, at which the feeding roller conveys the picked up printing medium to the printing unit.

2. The image forming apparatus according to claim 1, wherein the printing unit comprises:
a photosensitive medium, on which a visual toner image is developed by toner supplied onto an electrostatic latent image formed by an irradiated light;
a transfer roller to transfer the toner image from the photosensitive medium to the printing medium; and
a fuser to fuse and fix the transferred toner image on the printing medium.

3. The image forming apparatus according to claim 2, wherein the pick-up velocity is smaller than a photosensitive medium velocity, at which the printing medium proceeds, and the feeding velocity is larger than the photosensitive medium velocity.

4. The image forming apparatus according to claim 3, wherein the pick-up velocity and the feeding velocity are determined such that the average moving velocity at which the printing medium proceeds from the position where a front end of the printing medium is picked up by the pick-up roller to the position where the front end approaches the photosensitive medium is equal to the photosensitive medium velocity.

5. An image forming method, comprising:
picking up a printing medium by a pick-up roller at a pickup velocity;
feeding the picked up printing medium to a printing unit at a feeding velocity, the feeding velocity being larger than the pickup velocity; and
printing an image on the printing medium by the printing unit.

6. The image forming method according to claim 5, wherein the printing of an image on the printing medium by the printing unit comprises:
forming an electrostatic latent image on a photosensitive medium by irradiating light thereon;
developing a visual toner image by supplying toner to the electrostatic latent image;
transferring the toner image from the photosensitive medium to the printing medium; and
fusing and fixing the transferred toner image on the printing medium.

7. The image forming method according to claim 6, wherein, in transferring the toner image, the pick-up velocity is smaller than a photosensitive medium velocity, at which the printing medium proceeds by the rotation of the photosensitive medium and the feeding velocity is larger than the photosensitive medium velocity.

8. The image forming method according to claim 7, wherein the pick-up velocity and the feeding velocity are determined such that the average moving velocity at which the printing medium proceeds from the position where a front end of the printing medium is picked up by the pick-up roller to the position where the front end approaches the photosensitive medium is equal to the photosensitive medium velocity.

9. An image forming apparatus, having a housing in which printing occurs, comprising:
a pick-up roller to pick up a printing medium from a printing medium cassette at a predetermined pick-up velocity; and
a feeding roller to convey the picked up printing medium through the housing at a predetermined feeding velocity, the feeding velocity being larger than the pick-up velocity.

10. The image forming apparatus according to claim 9, further comprising a printing unit to print images onto the printing medium, wherein the printing unit comprises:
a photosensitive medium, on which a visual toner image is developed;
a transfer roller to transfer the toner image from the photosensitive medium to the printing medium; and
a fuser to fuse the transferred toner image onto the printing medium.

11. The image forming apparatus to claim 10, wherein the visual toner image is developed by toner being supplied onto an electrostatic latent image on the photosensitive medium that is formed by a light beam irradiated onto the photosensitive medium.

12. The image forming apparatus according to claim 10, wherein the pick-up velocity is smaller than a photosensitive medium velocity, at which the printing medium proceeds while contacting the photosensitive medium, and the feeding velocity is larger than the photosensitive medium velocity.

13. The image forming apparatus according to claim 12, wherein the pick-up velocity and the feeding velocity are determined such that the average moving velocity at which the printing medium proceeds from the position where a front end of the printing medium is picked up by the pick-up roller to the position where the front end approaches the photosensitive medium is equal to the photosensitive medium velocity.

14. An image forming method, comprising:
picking up a printing medium at a pickup velocity;
feeding the picked up printing medium to a printing unit where an image is to be printed on the printing medium at a feeding velocity, the feeding velocity being larger than the pick-up velocity; and
printing the image on the printing medium.

15. The image forming method according to claim 14, wherein the picking up of the printing medium comprising picking up the printing medium with a pick-up roller.

16. The image forming method according to claim 14, wherein the printing of the image comprises:
forming an electrostatic latent image on a photosensitive medium by irradiating light thereon;
developing a visual toner image by supplying toner to the electrostatic latent image;
transferring the toner image from the photosensitive medium to the printing medium; and
fusing and fixing the transferred toner image on the printing medium.

17. The image forming method according to claim 16, wherein, in transferring the toner image, the pick-up velocity is smaller than a photosensitive medium velocity, at which the printing medium proceeds in contact with the photosensitive medium, and the feeding velocity is larger than the photosensitive medium velocity.

18. The image forming method according to claim 17, wherein the pick-up velocity and the feeding velocity are determined such that the average moving velocity at which the printing medium proceeds from the position where a front end of the printing medium is picked up by the pick-up roller to the position where the front end approaches the photosensitive medium is equal to the photosensitive medium velocity.
